(19) United States
(12) Patent Application Publication
(10) Pub. No.: US 2024/0411494 A1
(43) Pub. Date: Dec. 12, 2024

(54) ELECTRONIC DEVICE AND METHOD BY WHICH ELECTRONIC DEVICE DISPLAYS OBJECT

(71) Applicant: Samsung Electronics Co., Ltd., Suwon-si (KR)

(72) Inventors: Sungjae BAE, Suwon-si (KR); Jaehoon KIM, Suwon-si (KR); Jamin GOO, Suwon-si (KR); Hyelin KIM, Suwon-si (KR); Hanseung JUNG, Suwon-si (KR); Jinhwan HONG, Suwon-si (KR)

(21) Appl. No.: 18/808,679

(22) Filed: Aug. 19, 2024

Related U.S. Application Data
(63) Continuation of application No. PCT/KR2023/001855, filed on Feb. 8, 2023.

(30) Foreign Application Priority Data
Feb. 18, 2022 (KR) 10-2022-0021636

(51) Int. Cl. G06F 3/14; G06F 3/0485

(52) U.S. Cl. CPC G06F 3/14; G06F 3/0485

(57) ABSTRACT

An electronic device is provided. The electronic device includes a touch display, memory storing one or more computer programs, and one or more processors communicatively coupled to the touch display and the memory, wherein the one or more computer programs include computer-executable instructions that, when executed by the one or more processors individually or collectively, cause the electronic device to display, in a first area in the touch display, a first image corresponding to the first thumbnail image corresponding to a first object among a plurality of objects, in response to a first user input to the first thumbnail image, display, in a second area in the touch display, a plurality of thumbnail images corresponding to the first object, in response to a second user input to the first thumbnail image, and display a second image corresponding to the second object among the plurality of objects at a position where the first image of the first area is displayed and continuously display the plurality of thumbnail images corresponding to the first object in the second area, in response to a third user input to the second thumbnail image.

### CROSS-REFERENCE TO RELATED APPLICATION(S)

This application is a continuation application, claiming priority under § 365 (c), of an International application No. PCT/KR2023/001855, filed on Feb. 8, 2023, which is based on and claims the benefit of a Korean patent application number 10-2022-0021636, filed on Feb. 18, 2022, in the Korean Intellectual Property Office, the disclosure of which is incorporated by reference herein in its entirety.

### BACKGROUND

### 1. Field

The disclosure relates to an electronic device and a method for searching for and displaying an object (e.g., a photo or video) in the electronic device.

### 2. Description of Related Art

With the recent development of digital technology, various types of electronic devices, such as mobile communication terminals, smartphones, tablet personal computers (PCs), and wearable devices, are widely used.

These electronic devices are increasing not only in functionality but also in storage capacity. Accordingly, many applications may be installed on the electronic device, and the user may generate various contents according to use of the application and store the contents in the memory of the electronic device. For example, a plurality of contents may be stored in the electronic device for each application.

Recently, electronic devices provide various content viewer functions to users. For example, the electronic device may configure a content list widget (e.g., a filmstrip) at the bottom of the content viewer and provide the functions of expanding, moving, and searching for content to the user through the content list widget.

The above information is presented as background information only to assist with an understanding of the disclosure. No determination has been made, and no assertion is made, as to whether any of the above might be applicable as prior art with regard to the disclosure.

### SUMMARY

When viewing an object (e.g., photo or video) on an application installed on an electronic device, if another object is searched with a thumbnail portion for a specific object expanded, the expanded state of the thumbnail portion for the specific object may not be maintained, causing inconvenience.

Aspects of the disclosure are to address at least the above-mentioned problems and/or disadvantages and to provide at least the advantages described below. Accordingly, an aspect of the disclosure is to provide a method and device capable of maintaining an expanded state of a thumbnail portion for a specific object even when another object (e.g., photo or video) is searched.

Additional aspects will be set forth in part in the description which follows and, in part, will be apparent from the description, or may be learned by practice of the presented embodiments.

In accordance with an aspect of the disclosure, an electronic device is provided. The electronic device includes a touch display, memory storing one or more computer programs, and one or more processors communicatively coupled to the touch display and the memory, wherein the one or more computer programs include computer-executable instructions that, when executed by the one or more processors individually or collectively, cause the electronic device to display, in a first area in the touch display, a first image corresponding to a first thumbnail image corresponding to a first object among a plurality of objects, in response to a first user input to the first thumbnail image, display, in a second area in the touch display, a plurality of thumbnail images corresponding to the first object, in response to a second user input to the first thumbnail image, and display a second image corresponding to a second thumbnail image corresponding to a second object among the plurality of objects at a position where the first image of the first area is displayed and continuously display the plurality of thumbnail images corresponding to the first object in the second area, in response to a third user input to the second thumbnail image.

In accordance with another aspect of the disclosure, a method performed by an electronic device is provided. The method includes displaying, by the electronic device, in a first area in a display, a first image corresponding to a first thumbnail image corresponding to a first object among a plurality of objects, in response to a first user input to the first thumbnail image, displaying, by the electronic device, in a second area in the display, a plurality of thumbnail images corresponding to the first object, in response to a second user input to the first thumbnail image, displaying, by the electronic device a second image corresponding to a second thumbnail image corresponding to a second object among the plurality of objects at a position where the first image of the first area is displayed and continuously displaying the plurality of thumbnail images corresponding to the first object in the second area, in response to a third user input to the second thumbnail image.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include displaying, by the electronic device, in a first area in a display, a first image corresponding to a first thumbnail image corresponding to a first object among a plurality of objects, in response to a first user input to the first thumbnail image, displaying, by the electronic device, in a second area in the display, a plurality of thumbnail images corresponding to the first object, in response to a second user input to the first thumbnail image, and displaying, by the electronic device a second image corresponding to a second thumbnail image corresponding to a second object among the plurality of objects at a position where the first image of the first area is displayed and continuously displaying the plurality of thumbnail images corresponding to the first object in the second area, in response to a third user input to the second thumbnail image.

According to embodiments, an electronic device maintains an expanded state of a thumbnail portion for a specific object even when another object is searched with the thumbnail portion for the specific object (e.g., photo or video) expanded.

According to embodiments, the electronic device maintains or release the expanded state of the thumbnail portion for the specific object considering the user's intent.

According to embodiments, the electronic device expands the thumbnail portion for the specific object considering the device specifications.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to an embodiment of the disclosure;

FIG. 2 is a block diagram illustrating a display module according to an embodiment of the disclosure;

FIG. 3 is a block diagram illustrating an electronic device according to an embodiment of the disclosure;

FIG. 4 illustrates an example of an application screen according to an embodiment of the disclosure;

FIGS. 5A, 5B, 5C, 5D, 5E, 5F, and 5G illustrate examples of an application screen for describing an operation method of an electronic device according to various embodiments of the disclosure;

FIGS. 6A, 6B, and 6C illustrate examples of an application screen for describing a thumbnail expand release operation upon thumbnail screen-out of an electronic device according to various embodiments of the disclosure;

FIGS. 7A and 7B illustrate examples of an application screen for describing a thumbnail expand release operation after an electronic device plays an object according to various embodiments of the disclosure;

FIGS. 8A, 8B, and 8C illustrate examples of an application screen for expanding and displaying a thumbnail outside a filmstrip by an electronic device according to various embodiments of the disclosure;

FIGS. 9A, 9B, and 9C illustrate examples of an application screen for describing an operation in which an electronic device expands a thumbnail to an entirety of a filmstrip when selecting an object and, when a termination is input, the thumbnail is released according to various embodiments of the disclosure;

FIGS. 10A and 10B illustrate examples of an application screen for describing an operation in which a thumbnail expands to a preset area of a filmstrip when an electronic device selects an object according to various embodiments of the disclosure;

FIGS. 11A and 11B illustrate examples of an application screen for describing an operation in which a thumbnail expands within a filmstrip according to a screen size of an electronic device when the electronic device selects an object according to various embodiments of the disclosure;

FIG. 12 is a flowchart illustrating an operation method of an electronic device according to an embodiment of the disclosure;

FIG. 13 is a flowchart illustrating an operation in which an electronic device extracts a thumbnail image according to an embodiment of the disclosure; and

FIG. 14 is a flowchart illustrating an operation in which an electronic device determines whether to expand a thumbnail portion considering a user's intent according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

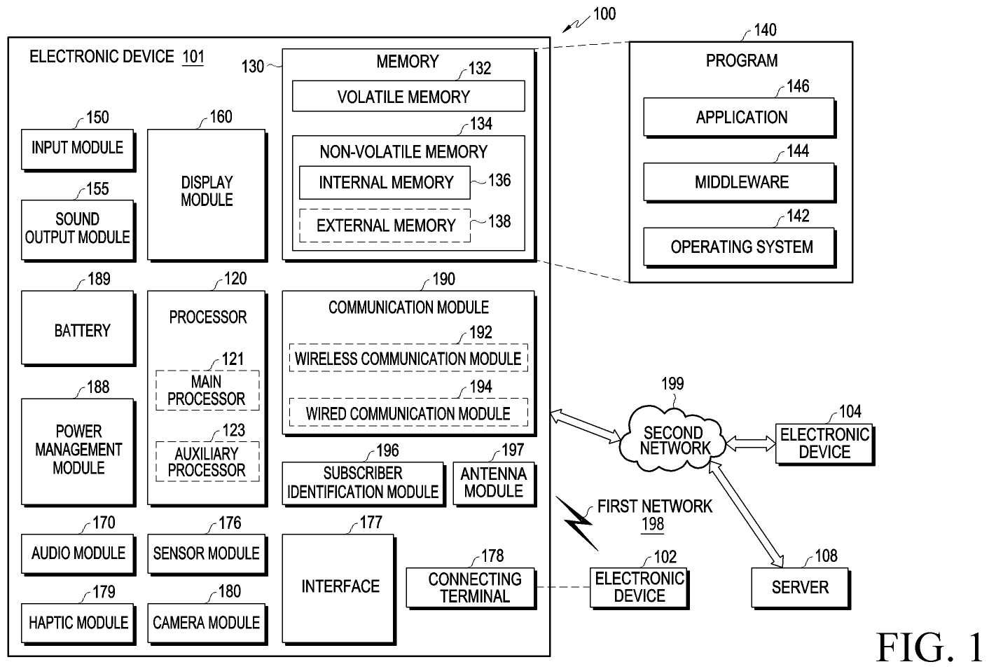

FIG. 1 is a block diagram illustrating an electronic device in a network environment according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mm Wave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

The electronic device according to embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Embodiments of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities. Some of the plurality of entities may be separately disposed in different components. According to embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

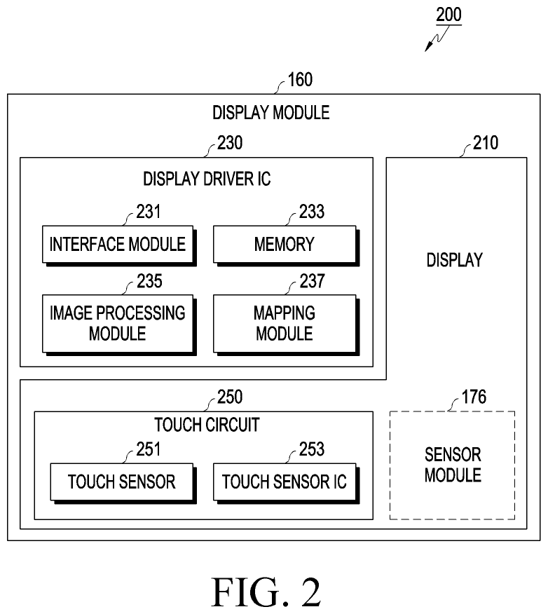

FIG. 2 is a block diagram 200 illustrating a display module 160 according to an embodiment of the disclosure.

Referring to FIG. 2, the display module 160 may include a display 210 and a display driver integrated circuit (DDI) 230 to control the display 110. The DDI 230 may include an interface module 231, memory 233 (e.g., buffer memory), an image processing module 235, or a mapping module 237. The DDI 230 may receive image information that contains image data or an image control signal corresponding to a command to control the image data from another component of the electronic device 101 via the interface module 231. For example, according to an embodiment, the image information may be received from the processor 120 (e.g., the main processor 121 (e.g., an application processor)) or the auxiliary processor 123 (e.g., a graphics processing unit) operated independently from the function of the main processor 121. The DDI 230 may communicate, for example, with touch circuitry 250 or the sensor module 176 via the interface module 231. The DDI 230 may also store at least part of the received image information in the memory 233, for example, on a frame by frame basis. The image processing module 235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 210. The mapping module 237 may generate a voltage value or a current value corresponding to the image data pre-processed or post-processed by the image processing module 135. According to an embodiment, the generating of the voltage value or current value may be performed, for example, based at least in part on one or more attributes of the pixels (e.g., an array, such as an RGB stripe or a pentile structure, of the pixels, or the size of each subpixel) of the display 210. At least some pixels of the display 210 may be driven, for example, based at least in part on the voltage value or the current value such that visual information (e.g., a text, an image, or an icon) corresponding to the image data may be displayed via the display 210.

According to an embodiment, the display module 160 may further include the touch circuitry 250. The touch circuitry 250 may include a touch sensor 251 and a touch sensor IC 253 to control the touch sensor 151. The touch sensor IC 253 may control the touch sensor 251 to sense a touch input or a hovering input with respect to a certain position on the display 210. To achieve this, for example, the touch sensor IC 253 may detect (e.g., measure) a change in a signal (e.g., a voltage, a quantity of light, a resistance, or a quantity of one or more electric charges) corresponding to the certain position on the display 210. The touch sensor IC 253 may provide input information (e.g., a position, an area, a pressure, or a time) indicative of the touch input or the hovering input detected to the processor 120. According to an embodiment, at least part (e.g., the touch sensor IC 253) of the touch circuitry 250 may be formed as part of the display 210 or the DDI 230, or as part of another component (e.g., the auxiliary processor 123) disposed outside the display module 160.

According to an embodiment, the display module 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display 210, the DDI 230, or the touch circuitry 250)) of the display module 160. For example, when the sensor module 176 embedded in the display module 160 includes a biometric sensor (e.g., a fingerprint sensor), the biometric sensor may obtain biometric information (e.g., a fingerprint image) corresponding to a touch input received via a portion of the display 210. As another example, when the sensor module 176 embedded in the display module 160 includes a pressure sensor, the pressure sensor may obtain pressure information corresponding to a touch input received via a partial or whole area of the display 210. According to an embodiment, the touch sensor 251 or the sensor module 176 may be disposed between pixels in a pixel layer of the display 210, or over or under the pixel layer.

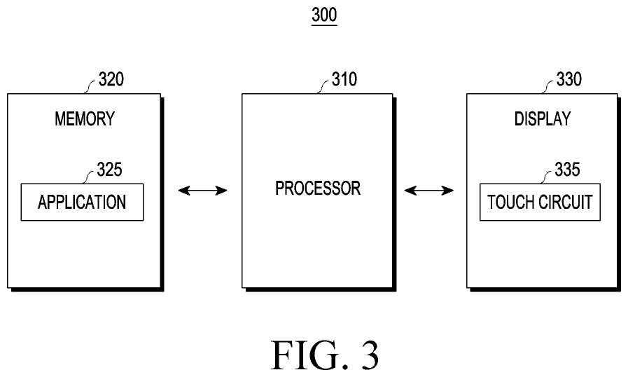

FIG. 3 is a block diagram illustrating an electronic device 300 according to an embodiment of the disclosure.

Referring to FIG. 3, an electronic device 300 (e.g., the electronic device 101 of FIG. 1) may include a processor 310 (e.g., the processor 120 of FIG. 1), memory 320 (e.g., the memory 130 of FIG. 1), and a display 330 (e.g., the display 210 of FIG. 2). According to an embodiment, the processor 310 may include at least one processor. According to an embodiment, an application 325 may be stored in the memory 320 as software. According to an embodiment, the application 325 may be implemented as a gallery application (or gallery viewer) that provides a service so that the user may search for and/or enjoy an image (or object) such as a photo, a video, or the like. According to an embodiment, the display 330 may include a touch circuit 335 (e.g., the touch circuitry 250 of FIG. 2) that receives the user's touch input. In the disclosure, the image refers to a photo (still image) or a moving image (video image), and may also be referred to as an object.

According to an embodiment, the processor 310 may display a plurality of thumbnail images corresponding to a plurality of objects on the display 330. According to an embodiment, the processor 310 may display, in a first area in the display, a first image corresponding to a first thumbnail in response to the user's first input (e.g., a click, tap, or touch input through the touch circuit 335) to the first thumbnail among a plurality of a plurality of thumbnail images corresponding to the first object among the plurality of objects. According to an embodiment, the processor 310 may display, in a second area in the display, a plurality of thumbnails corresponding to the object in response to the user's second input (e.g., a click, tap, or touch input through the touch circuit 335) to the first thumbnail. According to an embodiment, the processor 310 may display a second image corresponding to the second thumbnail at a position where the first image of the first area is displayed in response to the user's third input (e.g., a click, tap, or touch input through the touch circuit 335) to the second thumbnail corresponding to a second object among the plurality of objects while displaying the plurality of thumbnails corresponding to the first object in the second area in the display. According to an embodiment, the first area may be an area that is positioned at an upper end of a screen provided by the display 330 and where an image selected by the user is played. According to an embodiment, the second area may be a content list widget that is positioned at a lower end of the screen provided by the display 330 and includes a plurality of thumbnail images corresponding to the plurality of objects. According to an embodiment, the second area may be implemented in a form of a filmstrip and may include a plurality of thumbnail images selected according to the user's scroll input. According to an embodiment, the first object may be a video, and the second object may be a photo or a video.

According to an embodiment, the processor 310 may display, in the second area in the display, a plurality of thumbnails corresponding to the second object in response to the user's fourth input (e.g., a click, tap, or touch input through the touch circuit 335) to the second thumbnail image. According to an embodiment, the processor 310 may release expansion of the plurality of thumbnails corresponding to the first object (e.g., release expansion of the plurality of thumbnails and reduce to a preset number of thumbnails) in response to the user's fourth input to the second thumbnail. According to an embodiment, the processor 310 may display the first image at the position where the second image of the first area is displayed in response to the user's scroll input to the plurality of thumbnails of the first object. According to an embodiment, the processor 310 may release expansion of the plurality of thumbnails corresponding to the first object (e.g., release expansion of the plurality of thumbnails and reduce to a preset number of thumbnails) if the plurality of thumbnails corresponding to the first object move out of the screen displayed on the display in response to the user's scroll input to the plurality of thumbnails.

According to an embodiment, the processor 310 may differently set the number of the plurality of thumbnail corresponding to the first object displayed in the second area in the display depending on a type of the electronic device. For example, the processor 310 may set the number of the plurality of thumbnails for the first object to 3 if the electronic device is a cellular phone, and set the number of the plurality of thumbnails for the first object to 5 if the electronic device is a tablet PC. According to an embodiment, the processor 310 may arrange the plurality of thumbnail images for the first object displayed in the second area in the display in an area except for a predetermined area of each of a left side and a right side of the second area. For example, the processor 310 may arrange the plurality of thumbnails for the first object in an entire remaining area of the second area except for as large an area as a preset number (e.g., 1) of thumbnails at the left side of the second area and as large an area of the second area as a preset number (e.g., 1) of thumbnails at the right side of the second area.

According to an embodiment, the processor 310 may determine the number of the plurality of thumbnails corresponding to the first object displayed in the second area in the display based on at least one of a width of the electronic device, a size of the second area, a video ratio of the first object, and a width of a thumbnail. According to an embodiment, the processor 310 may extract a frame having a largest difference in delta value from a previous frame among frames in a set timestamp and determine the extracted frame as a thumbnail. According to an embodiment, the processor 310 may configure each of the plurality of thumbnails corresponding to the first object into an intra frame (I-frame) or a predicted frame (P-frame).

According to an embodiment, the processor 310 may control to maintain the expanded state of the thumbnail portion of the first object if it is determined that the user's intent of searching for the playback position remains when the user expands the thumbnail portion for the first object and moves the focus to the second object through the filmstrip while viewing the image. According to an embodiment, the processor 310 may determine that the user does not have the intent of searching for the playback position for the first object any longer when the expanded thumbnail portion of the first object moves out of the screen according to the user's scroll input and control to release the expanded state of the thumbnail portion of the first object. According to an embodiment, the processor 310 may be configured to close the expansion of the thumbnail portion when the expanded thumbnail portion of the first object is clicked to allow the user to use the filmstrip in her desired manner (e.g., expand video or identify the photo of the surroundings). According to an embodiment, the processor 310 may release expansion of the thumbnail portion for the first object when the video playback for the first object is ended while the user expands and views the thumbnail portion.

According to an embodiment, the processor 310 may expand the thumbnail portion for the object in an outer area of the filmstrip and play and/or search for an object without moving the filmstrip when the user clicks on the focused object. According to an embodiment, the processor 310 may expand the object to the entire filmstrip and play and/or search for the object when the user clicks on the focused object. According to an embodiment, the processor 310 may release expansion of the expanded thumbnail portion of the object in response to the user's end button input. According to an embodiment, when the user expands and views the thumbnail portion of the object, the processor 310 may expand and display the thumbnail portion of the object to a fixed length from the center of the screen regardless of the video length of the object. According to an embodiment, the processor 310 may maintain areas of the same ratio (e.g., filmstrip items not expanded) on both sides of the expanded filmstrip area when expanding the thumbnail portion of the object.

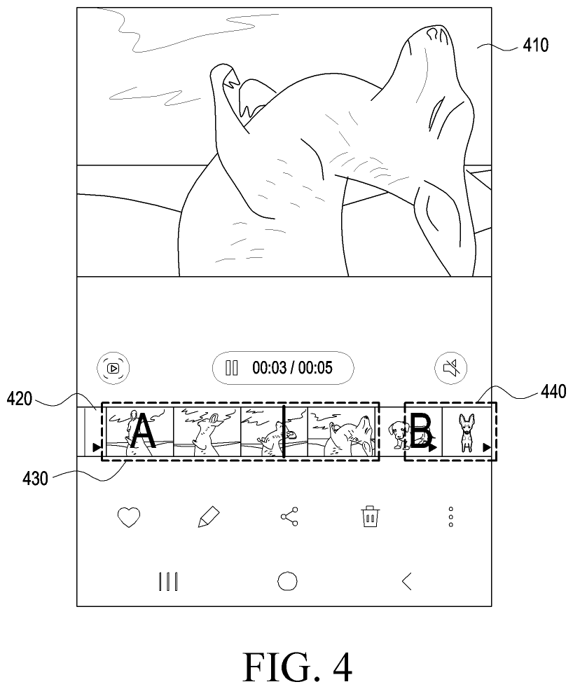

FIG. 4 illustrates an example of an application screen according to an embodiment of the disclosure.

Referring to FIG. 4, an object (e.g., photo or video) selected by the user may be displayed in a large size in a first area 410 at an upper end of the application screen, and a plurality of thumbnails for the object (e.g., photo or video) may be displayed in a small size in the form of a filmstrip in a second area 420 at a lower end of the application screen. According to an embodiment, the filmstrip may be configured to include a preset number of thumbnails for at least one object (e.g., photo or video), and the user may quickly select a desired scene by entering a scroll input to the filmstrip. According to an embodiment, the filmstrip may configure a different number of thumbnails depending on the video length of the object. According to an embodiment, the filmstrip may configure a fixed number of thumbnails regardless of the video length of the object.

According to an embodiment, the second area 420 in the application screen may include a first view 430 in which the thumbnail portion is expanded to display a plurality of thumbnails in response to the user's input, and a second view 440 in which a thumbnail for each object (where the thumbnail portion for the object is not expanded) is displayed. According to an embodiment, among the plurality of thumbnails displayed in the first view 430, one thumbnail may be selected in response to a user input. According to an embodiment, the thumbnail selected by the user input among the plurality of thumbnails displayed in the first view 430 may be displayed in the first area 410 in the application screen.

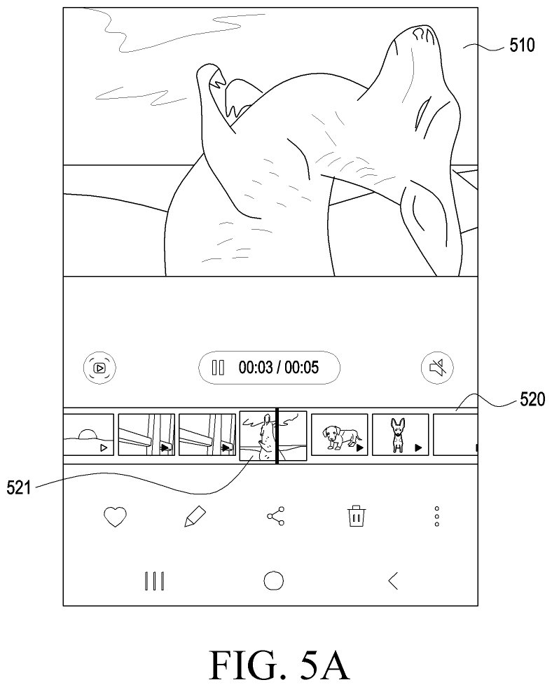

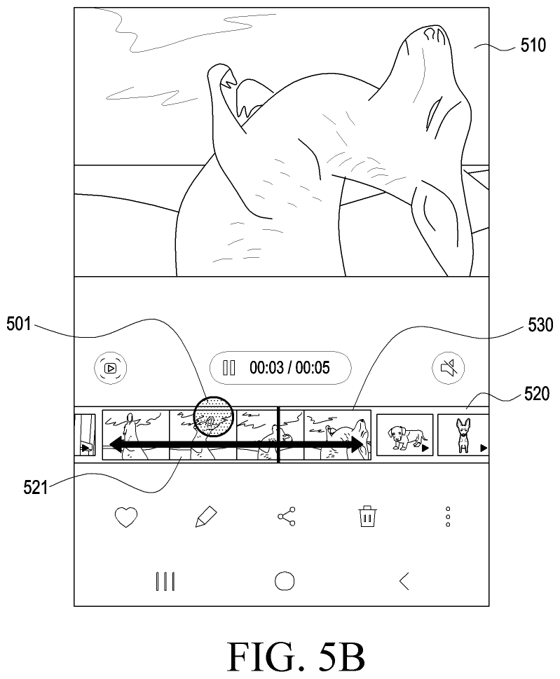

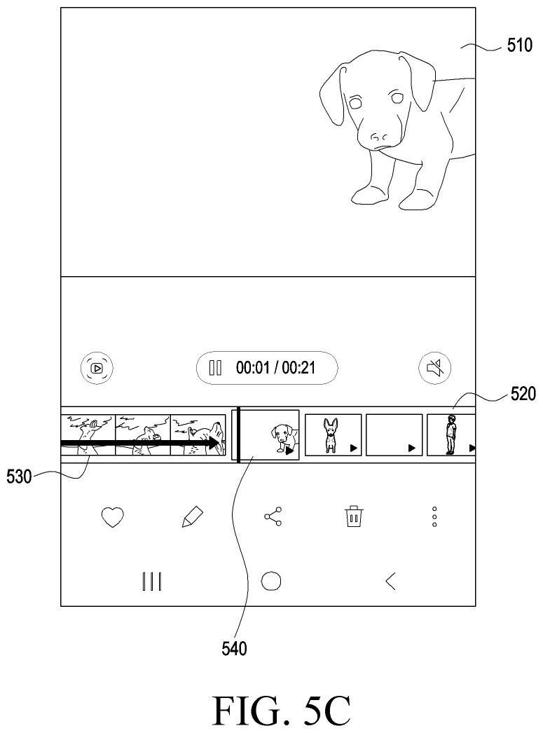

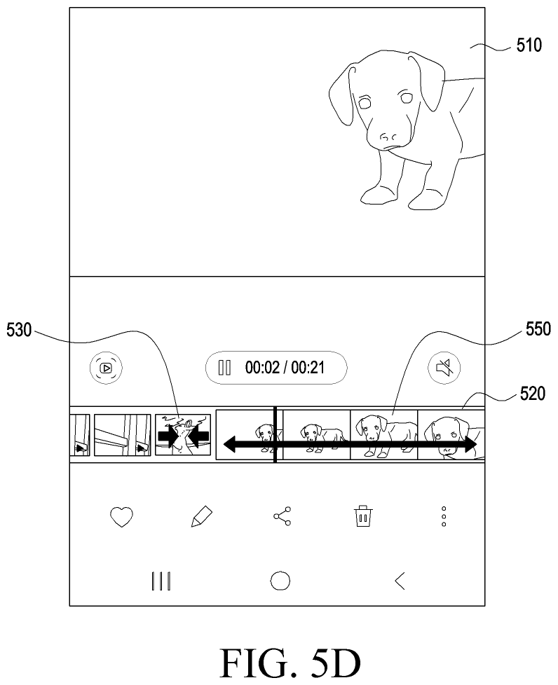

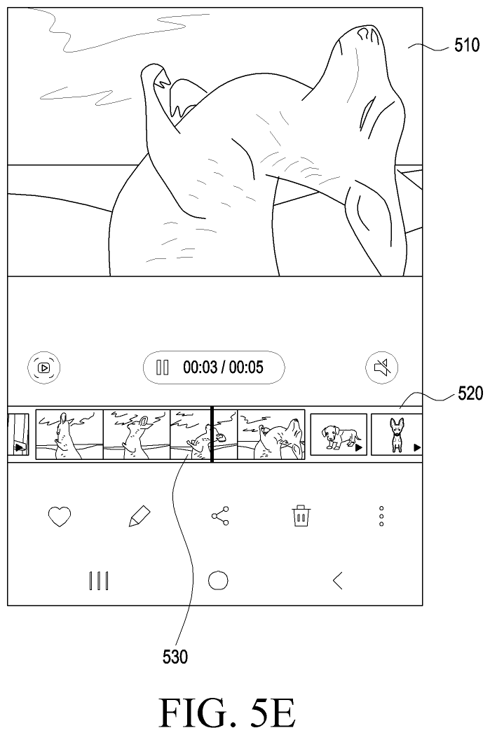

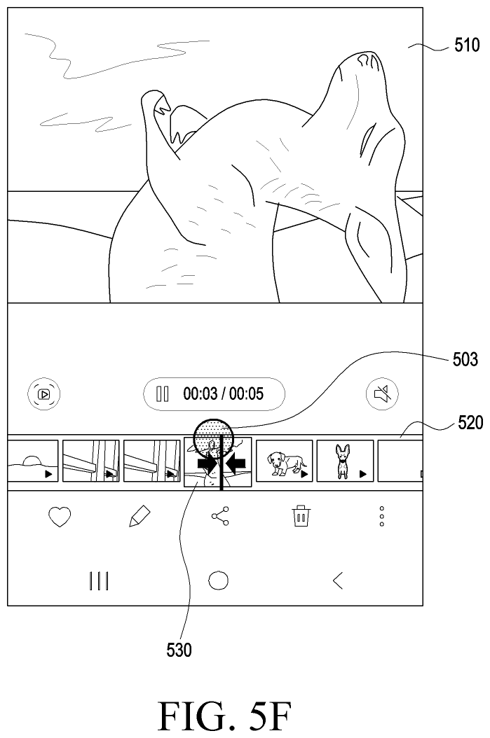

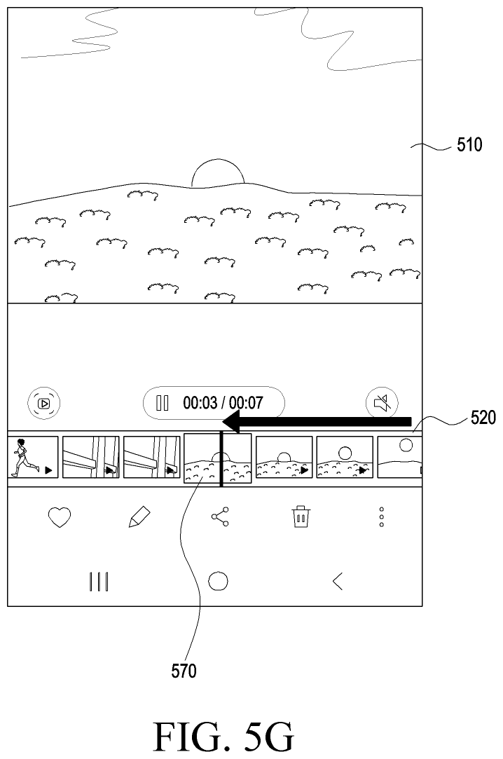

FIGS. 5A, 5B, 5C, 5D, 5E, 5F, and 5G illustrate examples of an application screen for describing an operation method of an electronic device according to various embodiments of the disclosure.

Referring to FIG. 5A, an object (e.g., photo or video) selected by the user may be displayed in a large size in a first area 510 in the application screen, and a plurality of thumbnails for the object (e.g., photo or video) may be displayed in a small size in the form of a filmstrip in a second area 520 in the application screen. According to an embodiment, if the user selects a thumbnail 521 for an object by scrolling the filmstrip (e.g., the user's tap input), the image corresponding to the corresponding object may be played in the first area 510.

Referring to FIGS. 5A and 5B, if the user again taps (501) the thumbnail 521 for the object being played, the thumbnail 521 may be expanded, displaying a plurality of thumbnails 530. According to an embodiment, the user may scroll the plurality of thumbnails 530 in which the thumbnail 521 has been expanded to search for and/or select a desired thumbnail in the object and search for a screen to which the user desires to move.

Referring to FIGS. 5B and 5C, if the user scrolls the object list (or content list) displayed in the second area 520 in the application screen to select a thumbnail 540 corresponding to another object, the image corresponding to the thumbnail 540 may be displayed in the first area 510 in the application screen. According to an embodiment, while the image corresponding to the thumbnail 540 is displayed in the first area 510 in the application screen, the plurality of thumbnails 530 in which the thumbnail 521 has been expanded is not expansion-released, but may continuously be displayed in the second area 520 in the application screen.

Referring to FIGS. 5C and 5D, if the user taps the thumbnail 540 corresponding to the video being played, the thumbnail 540 may be expanded, and a plurality of thumbnails 550 may be displayed. According to an embodiment, while the plurality of thumbnails 550 in which the thumbnail 540 has been expanded are displayed in the second area 520 in the application screen, the plurality of thumbnails 530 may be expansion-released, and be reduced to one thumbnail and displayed in the second area 520 in the application screen.

Referring to FIGS. 5C and 5E, when the user scrolls back to the position of the plurality of thumbnails 530 and searches for a corresponding thumbnail without tapping the thumbnail 540 being played, the image corresponding to the thumbnail corresponding to the position to which the user has scrolled may be played in the first area 510.

Referring to FIGS. 5B, 5E, and 5F, if the user taps (503) once more the plurality of thumbnails 530 in which the thumbnail 521 has been expanded, the plurality of expanded thumbnails 530 may be folded to the original size, and the image corresponding to the corresponding thumbnail may be continuously played in the first area 510.

Referring to FIGS. 5B, 5E, and 5G, if the user scrolls the filmstrip to select a thumbnail 570 corresponding to another object, and the plurality of expanded thumbnails 530 disappear from the screen, the expansion of the plurality of expanded thumbnails 530 may be released (not directly shown on the screen). According to an embodiment, when the user scrolls the filmstrip back to the position of the thumbnail 521 which was previously selected, it may be in a state in which expansion of the plurality of expanded thumbnails 530 has been released.

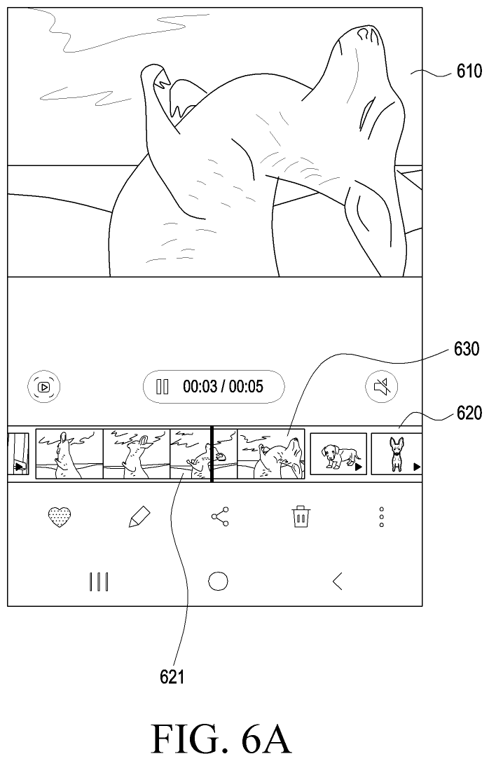

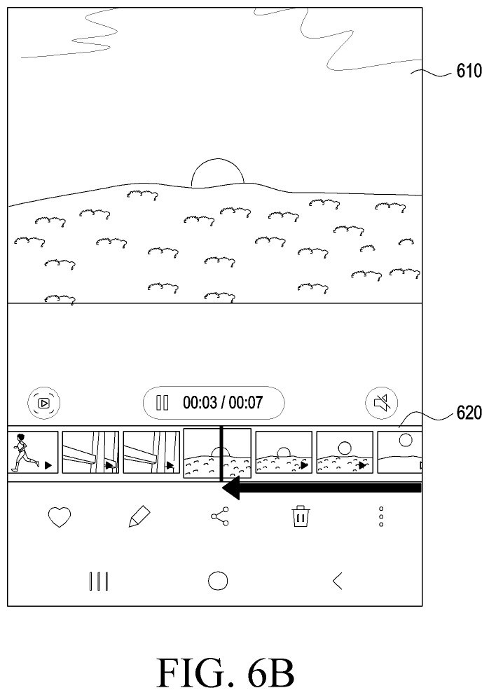

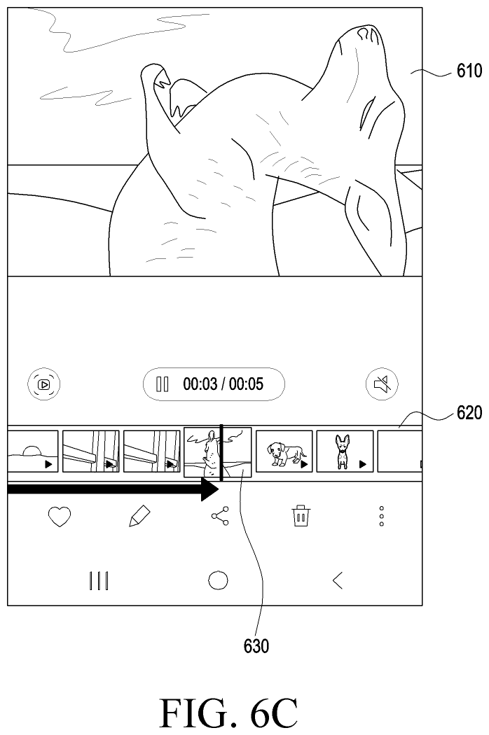

FIGS. 6A, 6B, and 6C illustrate examples of an application screen for describing a thumbnail expand release operation upon thumbnail screen-out of an electronic device according to various embodiments of the disclosure.

Referring to FIG. 6A, an object (e.g., photo or video) selected by the user may be displayed in a large size in a first area 610 in the application screen, and a plurality of thumbnails for the object (e.g., photo or video) may be displayed in a small size in the form of a filmstrip in a second area 620 in the application screen. According to an embodiment, if the user selects a thumbnail 621 for an object by scrolling the filmstrip (e.g., the user's tap input), the image corresponding to the corresponding object may be played in the first area 610. According to an embodiment, if the user again taps the thumbnail 621 for the image being played, the thumbnail 621 may be expanded, so that the plurality of thumbnails 630 may be displayed in the second area 620. According to an embodiment, the user may scroll the plurality of thumbnails 630 in which the thumbnail 621 has been expanded to search for and/or select a desired thumbnail in the object.

Referring to FIGS. 6A and 6B, if the user scrolls the filmstrip to search for another object and the plurality of thumbnails 630 disappear from the screen while the plurality of thumbnails 630 in which the thumbnail 621 has been expanded are displayed in the second area 620, expansion of the plurality of expanded thumbnails 630 may be released (not directly shown on the screen).

Referring to FIGS. 6A to 6C, when the user scrolls the filmstrip back to the position of the thumbnail 621 which was previously selected, it may be in a state in which expansion of the plurality of expanded thumbnails 630 has been released.

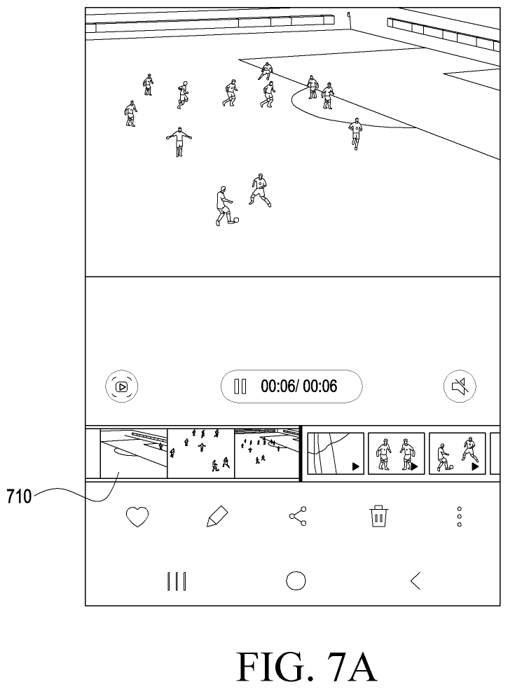

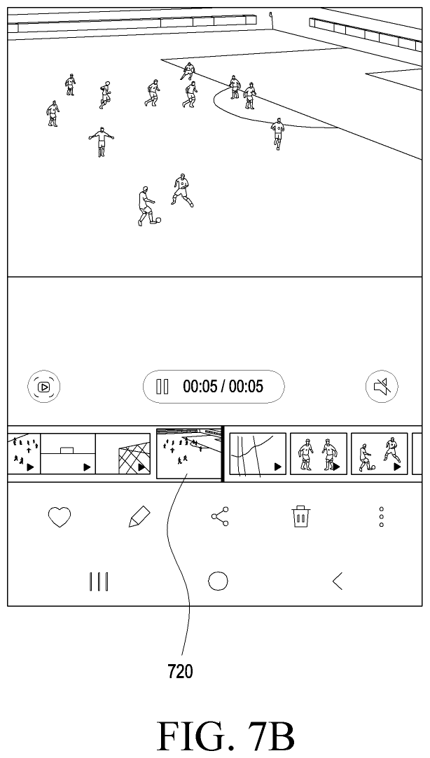

FIGS. 7A and 7B illustrate examples of an application screen for describing a thumbnail expand release operation after an electronic device plays an image according to various embodiments of the disclosure.

Referring to FIGS. 7A and 7B, if playback of the video corresponding to the plurality of expanded thumbnails 710 is completed, expansion of the plurality of expanded thumbnails 710 may be released, and the shrunken thumbnail 720 may be displayed on the filmstrip.

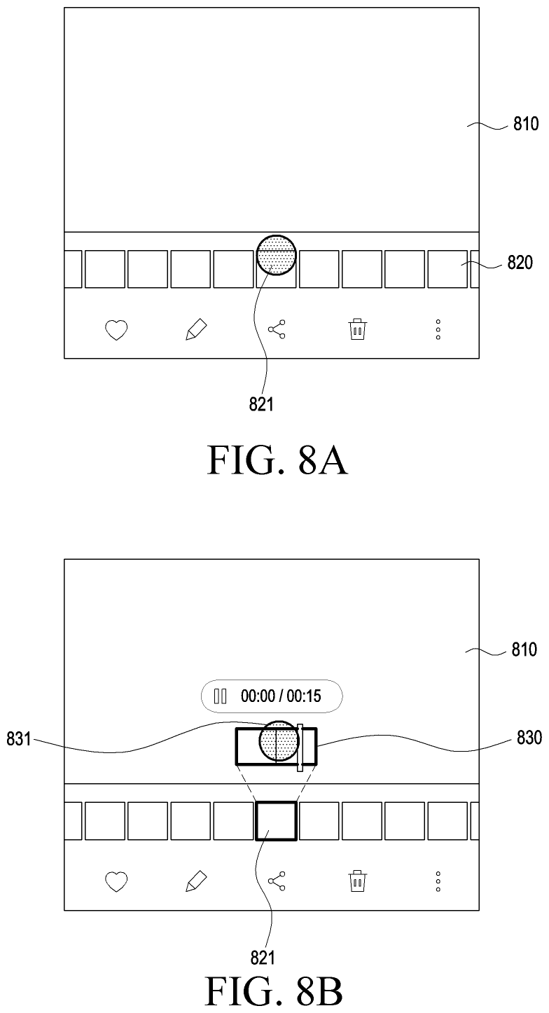

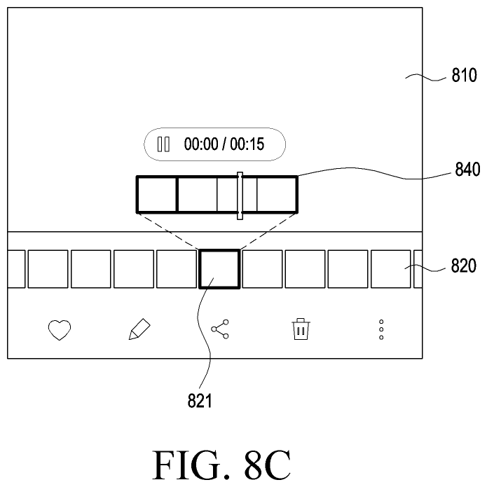

FIGS. 8A, 8B, and 8C illustrate examples of an application screen for expanding and displaying a thumbnail outside a filmstrip by an electronic device according to various embodiments of the disclosure.

Referring to FIG. 8A, an object (e.g., photo or video) selected by the user may be displayed in a large size in a first area 810 in the application screen, and a plurality of thumbnails for the object (e.g., photo or video) may be displayed in a small size in the form of a filmstrip in a second area 820 in the application screen. According to an embodiment, if the user selects a thumbnail 821 for an object by scrolling the filmstrip (e.g., the user's tap or click input), the image corresponding to the corresponding object may be played in the first area 810.

Referring to FIGS. 8A and 8B, if the user scrolls the filmstrip to select a thumbnail 821 for the object (e.g., the user's tap or click input), a film 830 constituted of a preset number (e.g., two) of thumbnails may be generated and/or displayed in a separate area from the filmstrip screen, outside the filmstrip.

Referring to FIGS. 8B and 8C, if the user clicks (831) the film 830 constituted of the preset number (e.g., two) of thumbnails, an expanded film 840 constituted of a preset number (e.g., four) of thumbnails may be expanded and displayed in a separate area from the filmstrip screen. According to an embodiment, the film 840 generated by clicking on the film 830 may be configured to include more thumbnails than the film 830.

According to an embodiment, the user may search for thumbnails in the corresponding object while scrolling the thumbnails in the expanded film 840. According to an embodiment, the number of thumbnails constituting the expanded film 840 may be set to differ depending on the length of the object (e.g., video). According to an embodiment, if the user clicks on the expanded film 840, expansion may be released, and the expanded film 840 may be reduced to a film 830 constituted of a preset number (e.g., two) of thumbnails.

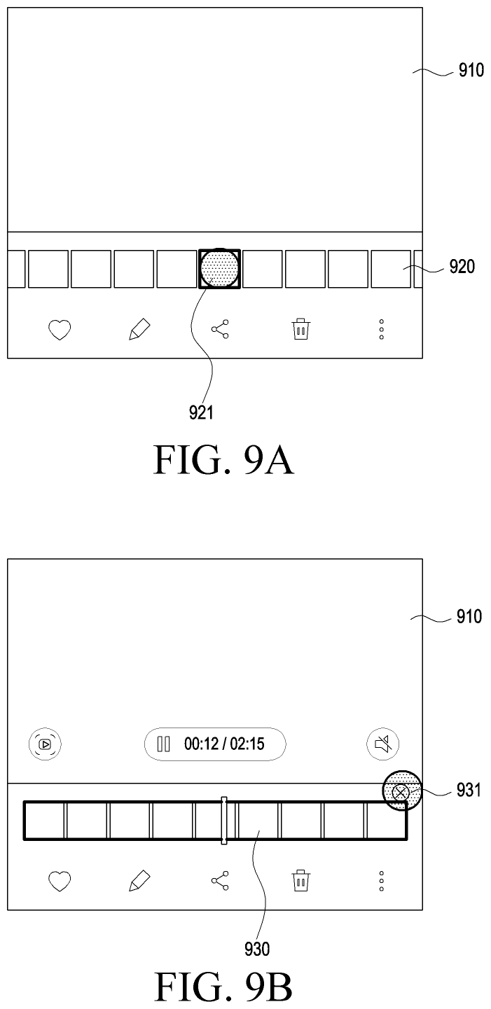

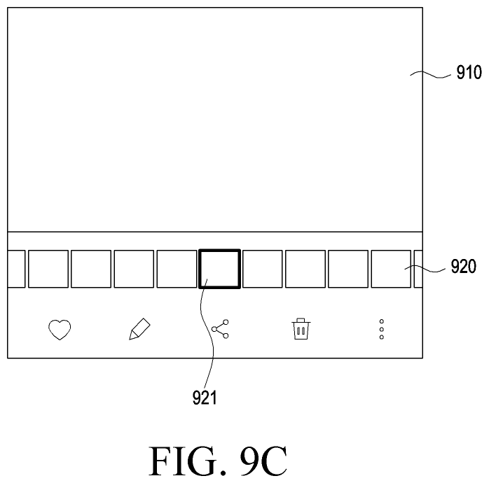

FIGS. 9A, 9B, and 9C illustrate examples of an application screen for describing an operation in which an electronic device expands a thumbnail to the entirety of a filmstrip when selecting an image and, when a termination is input, the thumbnail is released according to various embodiments of the disclosure.

Referring to FIG. 9A, an object (e.g., photo or video) selected by the user may be displayed in a first area 910 in the application screen, and a plurality of thumbnails for the object (e.g., photo or video) may be displayed in the form of a filmstrip in a second area 920 in the application screen. According to an embodiment, if the user selects a thumbnail 921 for an object by scrolling the filmstrip (e.g., the user's tap or click input), the image corresponding to the corresponding object may be played in the first area 910.

Referring to FIGS. 9A and 9B, if the user scrolls the filmstrip to select a thumbnail 921 corresponding to the object (e.g., the user's tap or click input), the plurality of thumbnails corresponding to the corresponding object may be expanded to the entire filmstrip, and be displayed in the form of a film 930. According to an embodiment, the number of thumbnails included in the film 930 expanded to the entire filmstrip may be set to be the same regardless of the video playback length of the object. Referring to FIGS. 9B and 9C, if the user clicks on the end button 931 for the film 930 expanded to the entire filmstrip, the expansion of the film 930 expanded to the entire filmstrip may be released.

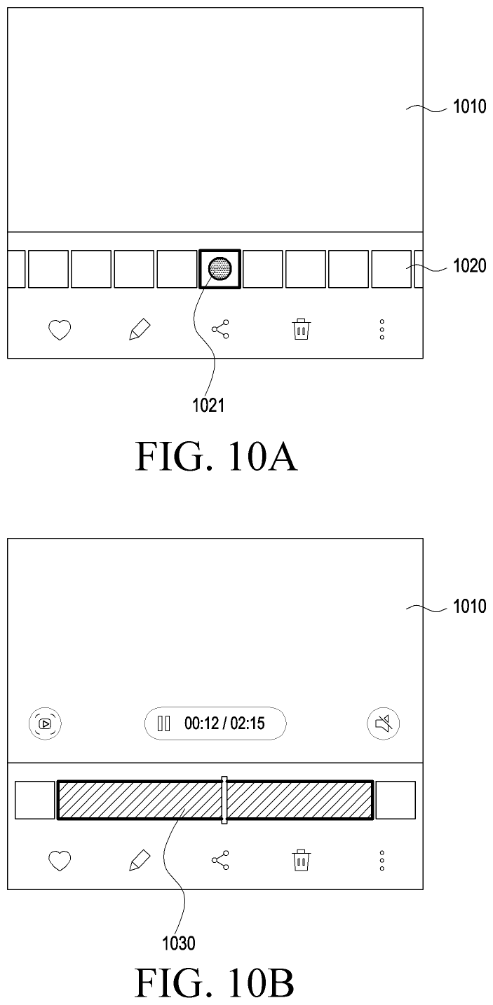

FIGS. 10A and 10B illustrate examples of an application screen for describing an operation in which a thumbnail expands to a preset area of a filmstrip when an electronic device selects an object according to various embodiments of the disclosure.

Referring to FIG. 10A, an object (e.g., photo or video) selected by the user may be displayed in a first area 1010 in the application screen, and a plurality of thumbnails for the object (e.g., photo or video) may be displayed in the form of a filmstrip in a second area 1020 in the application screen. According to an embodiment, if the user selects a thumbnail 1021 for an object by scrolling the filmstrip (e.g., the user's tap or click input), the image for the corresponding object may be played in the first area 1010.

Referring to FIGS. 10A and 10B, if the user scrolls the filmstrip to select a thumbnail 1021 for the object (e.g., the user's tap or click input), the plurality of thumbnails corresponding to the corresponding object may be displayed in the form of an expanded film 1030 except for the same area on the left and right sides of the screen center. According to an embodiment, the number of the plurality of thumbnails included in the film 930 expanded to the entire filmstrip may be set to be the same regardless of the video playback length of the object.

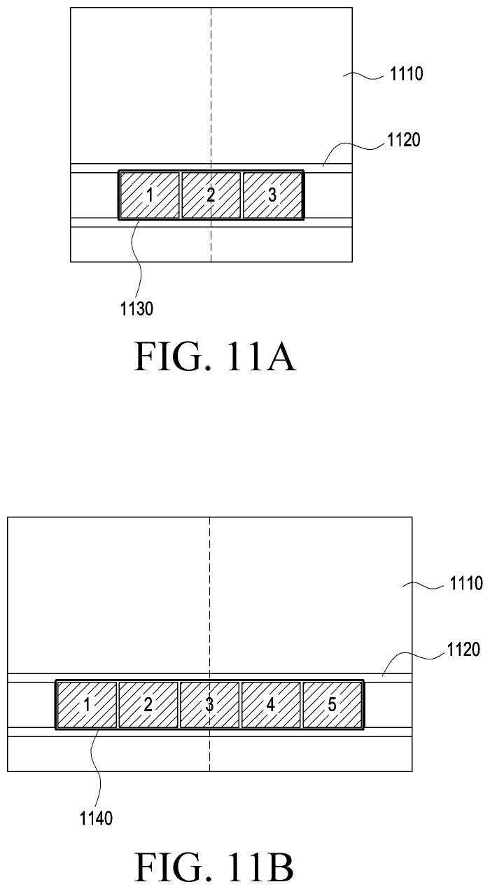

FIGS. 11A and 11B illustrate examples of an application screen for describing an operation in which a thumbnail expands within a filmstrip according to the screen size of an electronic device when the electronic device selects an object according to various embodiments of the disclosure.

Referring to FIG. 11A, an object (e.g., photo or video) selected by the user may be displayed in a first area 1110 in the application screen of a first electronic device (e.g., a cellular phone), and a set number (e.g., three) of thumbnails 1130 for the object (e.g., photo or video) may be displayed in the form of a filmstrip in a second area 1120 in the application screen of the first electronic device. Referring to FIG. 11B, an object (e.g., photo or video) selected by the user may be displayed in a first area 1110 in the application screen of a second electronic device (e.g., a tablet PC), and a set number (e.g., five) of thumbnails 1140 for the object (e.g., photo or video) may be displayed in the form of a filmstrip in a second area 1120 in the application screen of the second electronic device.

According to an embodiment, the number of thumbnails included in the filmstrip may be set to differ depending on the type of electronic device. According to an embodiment, the number of thumbnails in the filmstrip may be set depending on the device type with respect to the center of the screen, and a predetermined ratio of margin may be set at each of the left and right sides of the second area 1120 in the application screen. According to an embodiment, the number of thumbnails may be increased so that the characteristic appearance of the object (e.g., video) may be included as much as possible in the thumbnails included in the filmstrip. According to an embodiment, the thumbnail may be generated by considering the ratio of the video. For example, for a horizontal ratio video which is longer horizontally, a thumbnail may be configured to be longer horizontally. For example, for a vertical ratio video which is longer vertically, a thumbnail may be configured to be longer vertically. According to an embodiment, the number of thumbnails may vary depending on the ratio of the video when placed in a designated area.

According to an embodiment, the electronic device may extract a thumbnail image considering the ratio of the video within a preset timestamp. According to an embodiment, for a horizontal ratio video which is longer horizontally, the electronic device may extract a thumbnail image so that the thumbnail image is configured to be longer horizontally. According to an embodiment, for a vertical ratio video which is longer vertically, the electronic device may extract a thumbnail image so that the thumbnail image is configured to be longer vertically. According to an embodiment, the electronic device may determine the number of the thumbnails considering the ratio of the video within a preset timestamp.

According to an embodiment, the number of expanded thumbnails (expanded thumbnail count) may be derived through Equation 1.

expanded thumbnail count=((dW×n%))/tW*max(2, min(ratio, 1/2)) Equation 1

Here, dW may be the device width, n % may be the filmstrip expanded area, and tW may be the filmstrip video thumbnail width. Here, ratio means video ratio (VideoRatio) and may be determined by Equation 2 below.

VideoRatio(ratio)=video height/video width Equation 2

Here, video height may be the height of the video, and video width may be the width of the video.

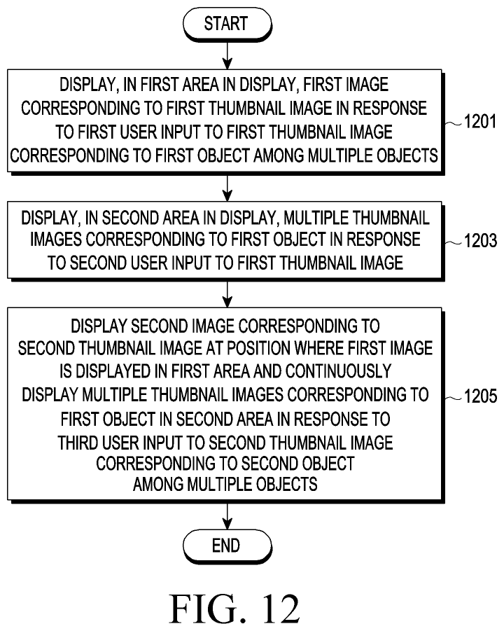

FIG. 12 is a flowchart illustrating an operation method of an electronic device according to an embodiment of the disclosure.

Referring to FIG. 12, an electronic device (e.g., the electronic device 101 of FIG. 1 or the electronic device 300 of FIG. 3) may display a plurality of thumbnail images corresponding to a plurality of objects on a display. According to an embodiment, an object may be implemented as a photo or video that may be displayed in a gallery application.

In operation 1201, the electronic device may display, in a first area in the display, a first image corresponding to a first thumbnail image corresponding to a first object among a plurality of objects, in response to a first input to the first thumbnail image.

In operation 1203, the electronic device may display, in a second area in the display, a plurality of thumbnail images corresponding to the first object, in response to a second user input to the first thumbnail image.

In operation 1205, the electronic device may display a second image corresponding to a second thumbnail image corresponding to a second object among the plurality of objects at a position where the first image of the first area is displayed and continuously display the plurality of thumbnail images corresponding to the first object in the second area, in response to a third user input to the second thumbnail image.

According to an embodiment, the first object may be a video, and the second object may be a photo or a video. According to an embodiment, the electronic device may display a plurality of thumbnail images corresponding to the second object in the second area in the display in response to a fourth user input to the second thumbnail image. According to an embodiment, the electronic device may release expansion of the plurality of thumbnail images in response to the fourth user input to the second thumbnail image.

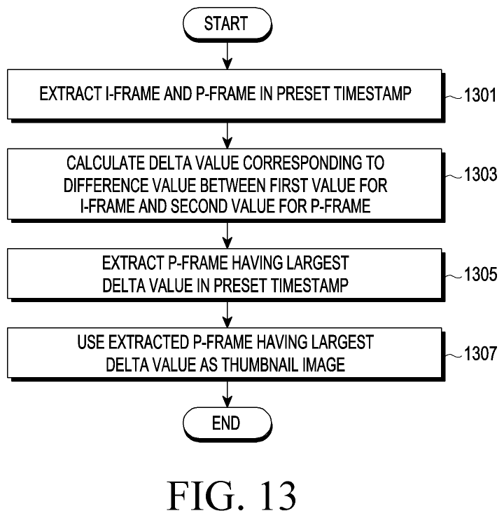

FIG. 13 is a flowchart illustrating an operation in which an electronic device extracts a thumbnail image according to an embodiment of the disclosure.

Referring to FIG. 13, in operation 1301, an electronic device (e.g., the electronic device 101 of FIG. 1 or the electronic device 300 of FIG. 3) may extract an intra frame (I-Frame) and a predicted frame (P-Frame) in a preset timestamp. According to an embodiment, the I-Frame may mean a representative frame present for each time, and because of being the representative frame for the corresponding time, this may have an error rather than being an accurate frame for the timestamp. According to an embodiment, a predicted frame (P-Frame) needs to be extracted to obtain an accurate frame within a set timestamp range, and when extracting the P-Frame, the electronic device may consume lots of CPU resources and/or time.

In operation 1303, the electronic device may calculate a delta value corresponding to a difference value between a first value (e.g., the size of RGB data of the I-Frame) for the I-Frame and a second value (e.g., the size of RGB data of the P-Frame) for the P-Frame in the preset timestamp.

In operation 1305, the electronic device may extract the P-Frame having the largest delta value among the plurality of P-Frames in the present timestamp (e.g., the P-Frame having the largest capacity among the plurality of P-Frames).

In operation 1307, the electronic device may determine to use the extracted P-Frame having the largest delta value as a thumbnail image. According to an embodiment, to extract the plurality of thumbnails included in the filmstrip, the electronic device may obtain the frame corresponding to the plurality of thumbnails. According to an embodiment, the frame corresponding to the plurality of thumbnails may be constituted of an intra frame (I-Frame) and/or a predicted frame (P-Frame) in a preset timestamp range. For example, the electronic device may use an I-Frame included in a first range of the timestamp as a thumbnail image, a P-Frame having the largest delta value included in a second range of the timestamp as a thumbnail image, and an I-Frame included in a third range of the timestamp as a thumbnail image.

According to an embodiment, when the electronic device expands the size of the expansion area of the filmstrip regardless of the video playback length of the object, a short image may require an additional thumbnail other than the thumbnail obtained from the I-Frame. According to an embodiment, if the expansion area of the filmstrip is constituted of only I-Frames, for videos having a long GOP structure, no thumbnail may be extracted other than from the first frame, because of lack of an I-Frame. According to an embodiment, the electronic device may extract a P-Frame for thumbnails present after the I-Frame and use it as a thumbnail image.

According to an embodiment, since a short video has many thumbnails as compared with the video length, and may have little difference between the previous frame and the next frame, the electronic device may compare the difference in delta value from the previous I-Frame when obtaining the P-Frame and obtain the P-Frame having the largest change in delta value among the P-Frames in the preset timestamp and use it as a thumbnail. There may be other embodiments.

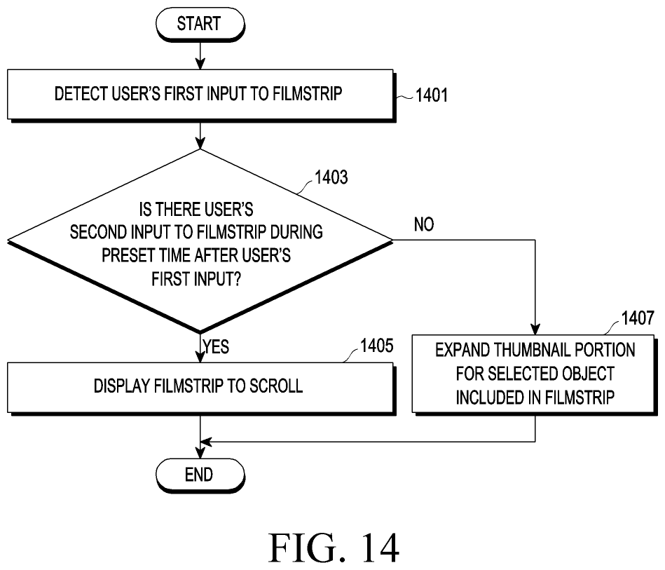

FIG. 14 is a flowchart illustrating an operation in which an electronic device determines whether to expand a thumbnail portion considering a user's intent according to an embodiment of the disclosure.

Referring to FIG. 14, in operation 1401, an electronic device (e.g., the electronic device 101 of FIG. 1 or the electronic device 300 of FIG. 3) may detect the user's first input (e.g., touch input) to a filmstrip displayed at a lower end of the screen through a display (e.g., the display module 160 of FIG. 1, the display 210 of FIG. 2, or the display 330 of FIG. 3).

In operation 1403, the electronic device may determine whether there is the user's second input (e.g., scroll input) to the filmstrip during a preset time (e.g., 200 ms) after the user's first input (e.g., touch input). According to an embodiment, the preset time may be set to various times depending on design specifications.

If there is the user's second input to the filmstrip during the preset time (e.g., 200 ms) (yes in 1403), in operation 1405, the electronic device may determine that there is the user's intent of searching for another object (e.g., photo or video) and display the filmstrip to scroll. If there is not the user's second input to the filmstrip during the preset time (e.g., 200 ms) (no in 1403), in operation 1407, the electronic device may expand the thumbnail portion for the object (e.g., video) selected by the user (or selected by a first input) included in the filmstrip (e.g., increase the number of thumbnails for the object) and display it.

According to an embodiment, when the user touches or quickly scrolls the filmstrip during the preset time (e.g., 200 ms) after the user's first input (e.g., touch input), the electronic device may control to scroll the filmstrip to allow the user to search for another object (e.g., photo or video). According to an embodiment, when the user does not touch or slowly scrolls the filmstrip during the preset time (e.g., 200 ms) after the user's first input (e.g., touch input), the electronic device may determine that there is the user's intent of searching for a playback position in the object and expand the thumbnail portion in the filmstrip for the object (e.g., video) (e.g., increase the number of thumbnails for the object) and display it.

In accordance with an aspect of the disclosure, an electronic device (e.g., the electronic device 101 of FIG. 1 or the electronic device 300 of FIG. 3) is provided. The electronic device includes a touch display (e.g., the display module 160 of FIG. 1, the display 210 of FIG. 2, or the display 330 of FIG. 3), memory storing one or more computer programs, and one or more processors (e.g., the processor 120 of FIG. 1 or the processor 310 of FIG. 3) communicatively coupled to the touch display and the memory, wherein the one or more computer programs include computer-executable instructions that, when executed by the one or more processors individually or collectively, cause the electronic device to display, in a first area in the touch display, a first image corresponding to a first thumbnail image corresponding to a first object among a plurality of objects, in response to a first user input to the first thumbnail image, display, in a second area in the touch display, a plurality of thumbnail images corresponding to the first object, in response to a second user input to the first thumbnail image, and display a second image corresponding to a second thumbnail image corresponding to a second object among the plurality of objects at a position where the first image of the first area is displayed and continuously display the plurality of thumbnail images corresponding to the first object in the second area, in response to a third user input to the second thumbnail image.

According to an embodiment, the first object may be a video, and the second object may be a photo or a video. According to an embodiment, the one or more computer programs further include computer-executable instructions that, when executed by the one or more processors individually or collectively, may cause the electronic device to display a plurality of thumbnail images corresponding to the second object in the second area in the display in response to a fourth user input to the second thumbnail image. According to an embodiment, the one or more computer programs further include computer-executable instructions that, when executed by the one or more processors individually or collectively, may cause the electronic device to reduce a number of the plurality of thumbnail images corresponding to the first object and display the plurality of thumbnail images in the second area in response to the fourth user input to the second thumbnail image. According to an embodiment, the one or more computer programs further include computer-executable instructions that, when executed by the one or more processors individually or collectively, may cause the electronic device to display the first image at a position where the second image of the first area is displayed in response to a scroll input to the plurality of thumbnail images corresponding to the first object. According to an embodiment, the one or more computer programs further include computer-executable instructions that, when executed by the one or more processors individually or collectively, may cause the electronic device to release expansion of the plurality of thumbnail images for the first object in case that the plurality of thumbnail images for the first object move out of a screen displayed on the display in response to a scroll input to the plurality of thumbnail images.

According to an embodiment, the one or more computer programs further include computer-executable instructions that, when executed by the one or more processors individually or collectively, may cause the electronic device to differently set a number of the plurality of thumbnail images corresponding to the first object displayed in the second area in the touch display depending on a type of the electronic device. According to an embodiment, the one or more computer programs further include computer-executable instructions that, when executed by the one or more processors individually or collectively, may cause the electronic device to arrange the plurality of thumbnail images corresponding to the first object displayed in the second area in the touch display in an area except for a predetermined area of each of a left side and a right side of the second area.

According to an embodiment, the one or more computer programs further include computer-executable instructions that, when executed by the one or more processors individually or collectively, may cause the electronic device to determine a number of the plurality of thumbnail images corresponding to the first object displayed in the second area in the display based on at least one of a width of the electronic device, a size of the second area, a video ratio of the first object, or a width of a thumbnail. According to an embodiment, the one or more computer programs further include computer-executable instructions that, when executed by the one or more processors individually or collectively, may cause the electronic device to extract a frame having a largest difference in delta value from a previous frame among frames in a set timestamp and determine the extracted frame as a thumbnail image. According to an embodiment, the one or more computer programs further include computer-executable instructions that, when executed by the one or more processors individually or collectively, may cause the electronic device to determine at least one of the plurality of thumbnail images corresponding to the first object as a predicted frame (P-frame) having a largest capacity among a plurality of P-frames in a set timestamp range.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a touch display;
a processor; and
memory storing instructions which, when executed by the processor, cause the electronic device to: display, in a first area in the touch display, a first image corresponding to a first thumbnail image corresponding to a first object among a plurality of objects, in response to a first user input to the first thumbnail image,
display, in a second area in the touch display, a plurality of thumbnail images corresponding to the first object, in response to a second user input to the first thumbnail image, and
display a second image corresponding to a second thumbnail image corresponding to a second object among the plurality of objects at a position where the first image of the first area is displayed and continuously display the plurality of thumbnail images corresponding to the first object in the second area, in response to a third user input to the second thumbnail image.

2. The electronic device of claim 1,
wherein the first object is a video, and
wherein the second object is a photo or a video.

3. The electronic device of claim 1, wherein the instructions further include computer-executable instructions that, when executed by the processor individually or collectively, cause the electronic device to display a plurality of thumbnail images corresponding to the second object in the second area in response to a fourth user input to the second thumbnail image.

4. The electronic device of claim 3, wherein the instructions further include computer-executable instructions that, when executed by the processor individually or collectively, cause the electronic device to:
reduce a number of the plurality of thumbnail images corresponding to the first object, and
display the plurality of thumbnail images in the second area in response to the fourth user input to the second thumbnail image.

5. The electronic device of claim 1, wherein the instructions further include computer-executable instructions that, when executed by the processor individually or collectively, cause the electronic device to display the first image at a position where the second image of the first area is displayed in response to a scroll input to the plurality of thumbnail images corresponding to the first object.

6. The electronic device of claim 1, wherein the instructions further include computer-executable instructions that, when executed by the processor individually or collectively, cause the electronic device to reduce a number of the plurality of thumbnail images for the first object in case that the plurality of thumbnail images for the first object move out of a screen displayed on the touch display in response to a scroll input to the plurality of thumbnail images.

7. The electronic device of claim 1, wherein the instructions further include computer-executable instructions that, when executed by the processor individually or collectively, cause the electronic device to differently set a number of the plurality of thumbnail images corresponding to the first object displayed in the second area in the touch display depending on a type of the electronic device.

8. The electronic device of claim 1, wherein the instructions further include computer-executable instructions that, when executed by the processor individually or collectively, cause the electronic device to arrange the plurality of thumbnail images corresponding to the first object displayed in the second area in the touch display in an area except for a predetermined area of each of a left side and a right side of the second area.

9. The electronic device of claim 1, wherein the instructions further include computer-executable instructions that, when executed by the processor individually or collectively, cause the electronic device to determine a number of the plurality of thumbnail images corresponding to the first object displayed in the second area in the touch display based on at least one of a width of the electronic device, a size of the second area, a video ratio of the first object, or a width of a thumbnail.

10. The electronic device of claim 1, wherein the instructions further include computer-executable instructions that, when executed by the processor individually or collectively, cause the electronic device to:
extract a frame having a largest difference in delta value from a previous frame among frames in a set timestamp, and
determine the extracted frame as a thumbnail image.

11. The electronic device of claim 1, wherein at least one of the plurality of thumbnail images corresponding to the first object is constituted of a predicted frame (P-frame) having a largest capacity among a plurality of P-frames in a set timestamp range.

12. A method performed by an electronic device, the method comprising:
displaying, by the electronic device, in a first area in a display, a first image corresponding to a first thumbnail image corresponding to a first object among a plurality of objects, in response to a first user input to the first thumbnail image;
displaying, by the electronic device, in a second area in the display, a plurality of thumbnail images corresponding to the first object, in response to a second user input to the first thumbnail image; and
displaying, by the electronic device a second image corresponding to a second thumbnail image corresponding to a second object among the plurality of objects at a position where the first image of the first area is displayed and continuously displaying the plurality of thumbnail images corresponding to the first object in the second area, in response to a third user input to the second thumbnail image.

13. The method of claim 12,
wherein the first object is a video, and
wherein the second object is a photo or a video.

14. The method of claim 12, further comprising:
displaying a plurality of thumbnail images corresponding to the second object in the second area in response to a fourth user input to the second thumbnail image;
reducing a number of the plurality of thumbnail images corresponding to the first object; and
displaying the plurality of thumbnail images in the second area in response to the fourth user input to the second thumbnail image.

15. The method of claim 12, further comprising:
displaying the first image at a position where the second image of the first area is displayed in response to a scroll input to the plurality of thumbnail images corresponding to the first object.

16. The method of claim 12, further comprising:
reducing a number of the plurality of thumbnail images for the first object in case that the plurality of thumbnail images for the first object move out of a screen displayed on the display in response to a scroll input to the plurality of thumbnail images.

17. The method of claim 12, further comprising:
differently setting a number of the plurality of thumbnail images corresponding to the first object displayed in the second area in the display depending on a type of the electronic device.

18. The method of claim 12, further comprising:
arranging the plurality of thumbnail images corresponding to the first object displayed in the second area in the display in an area except for a predetermined area of each of a left side and a right side of the second area.

19. One or more non-transitory computer-readable storage media storing one or more computer programs including computer-executable instructions that, when executed by one or more processors of an electronic device individually or collectively, cause the electronic device to perform operations, the operations comprising:
displaying, by the electronic device, in a first area in a display, a first image corresponding to a first thumbnail image corresponding to a first object among a plurality of objects, in response to a first user input to the first thumbnail image;
displaying, by the electronic device, in a second area in the display, a plurality of thumbnail images corresponding to the first object, in response to a second user input to the first thumbnail image; and
displaying, by the electronic device a second image corresponding to a second thumbnail image corresponding to a second object among the plurality of objects at a position where the first image of the first area is displayed and continuously displaying the plurality of thumbnail images corresponding to the first object in the second area, in response to a third user input to the second thumbnail image.

20. The one or more non-transitory computer-readable storage media of claim 19,
wherein the first object is a video, and
wherein the second object is a photo or a video.
